(19) United States
(12) Patent Application Publication
(10) Pub. No.: US 2023/0307963 A1
(43) Pub. Date: Sep. 28, 2023

(54) NOISE SUPPRESSION SHEET AND ELECTRIC CIRCUIT DEVICE HAVING THE SAME

(71) Applicant: TDK Corporation, Tokyo (JP)

(72) Inventors: Takuya YOSHIDA, Tokyo (JP); Michihisa TOKUI, Tokyo (JP); Noritaka CHIYO, Tokyo (JP)

(21) Appl. No.: 18/173,308

(22) Filed: Feb. 23, 2023

(30) Foreign Application Priority Data
Mar. 22, 2022 (JP) 2022-045153

(51) Int. Cl. H02J 50/70; H01F 27/33; H01F 27/36

(52) U.S. Cl. CPC H02J 50/70; H01F 27/33; H01F 27/36; H02J 50/10

(57) ABSTRACT

Disclosed herein is a noise suppression sheet that includes a substrate having a first through hole, and a conductor pattern provided on one surface of the substrate. The conductor pattern has a plurality of linear patterns extending in a first direction and a connection pattern connecting the plurality of linear patterns. The one surface of the substrate has a clearance area surrounded by the plurality of linear patterns and having no conductor pattern. The size of the clearance area in a second direction different from the first direction is larger than an arrangement pitch between the plurality of linear patterns in the second direction. The first through hole is formed in the clearance area.

### CROSS-REFERENCE TO RELATED APPLICATION

This application claims the benefit of Japanese Patent Application No. 2022-045153, filed on Mar. 22, 2022, the entire disclosure of which is incorporated by reference herein.

### BACKGROUND

The present disclosure relates to a noise suppression sheet and an electric circuit device having the same.

JP 2013-214705A discloses a shield including a first area connected to the ground and a comb-like second area connected to the first area.

However, in the shield described in JP 2013-214705A, comb-like conductors are arranged in high density in the second area, so that other devices cannot be disposed in this area.

### SUMMARY

A noise suppression sheet according to the present disclosure includes a substrate having a first through hole and a conductor pattern provided on one surface of the substrate. The conductor pattern has a plurality of linear patterns extending in a first direction and a connection pattern connecting the plurality of linear patterns. The one surface of the substrate has a clearance area surrounded by the plurality of linear patterns and having no conductor pattern. The size of the clearance area in a second direction different from the first direction is larger than the arrangement pitch between the plurality of linear patterns in the second direction. The first through hole is formed in the clearance area.

### BRIEF DESCRIPTION OF THE DRAWINGS

The above features and advantages of the present disclosure will be more apparent from the following description of certain preferred embodiments taken in conjunction with the accompanying drawings, in which:

FIG. 1 is a schematic cross-sectional view illustrating the configuration of an electric circuit device 1 according to one embodiment of the present disclosure;

FIG. 2 is a schematic plan view for explaining a state where the first and second circuit sheets S1 and S2 overlap each other;

FIG. 3 is a plan view for explaining the pattern shape of the second conductor pattern provided on the surface 21 of the second substrate 20;

FIG. 4 is a plan view for explaining the pattern shape of the third conductor pattern provided on the surface 22 of the second substrate 20;

FIG. 5 is a plan view for explaining the pattern shape of the coil pattern 100;

FIG. 6 is a plan view for explaining the pattern shape of the coil pattern 200;

FIG. 7 is an equivalent circuit diagram of the coil pattern CP1;

FIG. 8 is a schematic perspective view illustrating a state where a connector member 400 is connected to the terminal conductors E1 to E8;

FIG. 9 is a block diagram illustrating the electric circuit device 1 and a mobile communication device 4 to be wirelessly connected to the electric circuit device 1; and

FIG. 10 is a plan view for explaining the pattern shape of the noise suppression pattern N according to a modification.

### DETAILED DESCRIPTION OF THE EMBODIMENTS

An object of the present disclosure to provide a noise suppression sheet capable of preventing interference with other devices.

Preferred embodiments of the present disclosure will be explained below in detail with reference to the accompanying drawings.

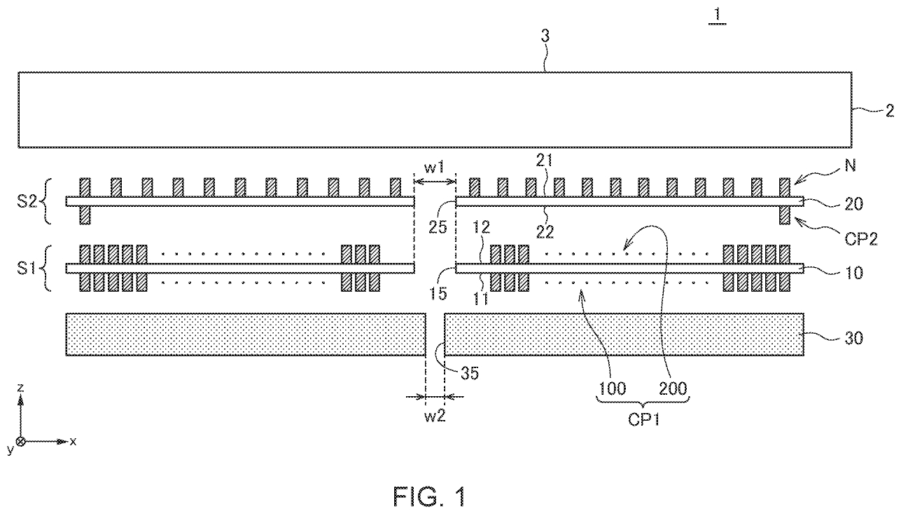

FIG. 1 is a schematic cross-sectional view illustrating the configuration of an electric circuit device 1 according to one embodiment of the present disclosure.

As illustrated in FIG. 1, the electric circuit device 1 according to the present embodiment includes first and second substrates 10 and 20, a coil pattern 100 formed on one surface 11 of the first substrate 10, a coil pattern 200 formed on the other surface 12 of the first substrate 10, a noise suppression pattern N formed on one surface 21 of the second substrate 20, and a coil pattern CP2 formed on the other surface 22 of the second substrate 20. Although details will be described later, the inner peripheral end of the coil pattern 100 and inner peripheral end of the coil pattern 200 are connected to each other through a plurality of through hole conductors penetrating the first substrate 10 to thereby constitute a coil pattern CP1.

The first substrate 10, a first conductor pattern including the coil pattern CP1 formed on the surfaces 11 and 12 of the first substrate 10, and the terminal conductors connected to the first conductor pattern constitute a first circuit sheet S1. The first circuit sheet S1 functions as a power transmission coil sheet used for a wireless power transmission device. The second substrate 20, a second conductor pattern including the noise suppression pattern N formed on the surface 21 of the second substrate 20, a third conductor pattern including the coil pattern CP2 formed on the surface 22 of the second substrate 20, and terminal conductors connected to the second and third conductor patterns constitute a second circuit sheet S2. The second circuit sheet S2 functions as a noise suppression sheet having a communication function such as NFC (Near Field Communication). The first and second substrates 10 and 20 are not particularly limited in material and may each be made of a flexible insulating material such as PET (polyethylene terephthalate) resin. The first circuit sheet S1 is covered with a sheet-like magnet member 30 from the side opposite to the second circuit sheet S2, enhancing inductance. To sufficiently increase the inductance of the coil pattern CP1 as a power transmission coil, the thickness of the magnetic member 30 may be made larger than the thicknesses of the first and second substrates 10 and 20.

The electric circuit device 1 according to the present embodiment has a housing 2, and a mobile communication device such as a smartphone to be charged is placed on a placement surface 3 of the housing 2, thus allowing the mobile communication device to be wirelessly charged. The placement surface 3 of the housing 2 is positioned on the side opposite to the magnetic member 30 with respect to the first and second circuit sheets S1 and S2. The second circuit sheet S2 is positioned closer to the placement surface 3 of the housing 2 than the first circuit sheet S1. The second circuit sheet S2 is disposed such that the surface 21 having the noise suppression pattern N faces the placement surface 3 of the housing 2.

The first substrate 10 has a through hole 15, the second substrate 20 has a first through hole 25, and the magnetic member 30 has a second through hole 35. The through holes 15, 25, and 35 overlap one another in the z-direction as the stacking direction. This allows access to the back surface of the housing 2 through the through holes 15, 25, and 35. For example, a device such as a temperature sensor for measuring the temperature of housing 2 may be disposed in the through holes 15, 25, and 35, or a cooling air may be supplied therethrough. The through holes 15, 25, and 35 are not particularly limited in size. For example, assuming that the size of the through holes 15 and 25 is W1 and that the size of the second through hole 35 is W2, W1>W2 may be satisfied. In this case, the peripheries of the through holes 15 and 25 are covered with the magnetic member 30 having a relatively large thickness, allowing parts of the first and second substrates 10 and 20 that are positioned around the through holes 15 and 25 to be supported by the magnetic member 30.

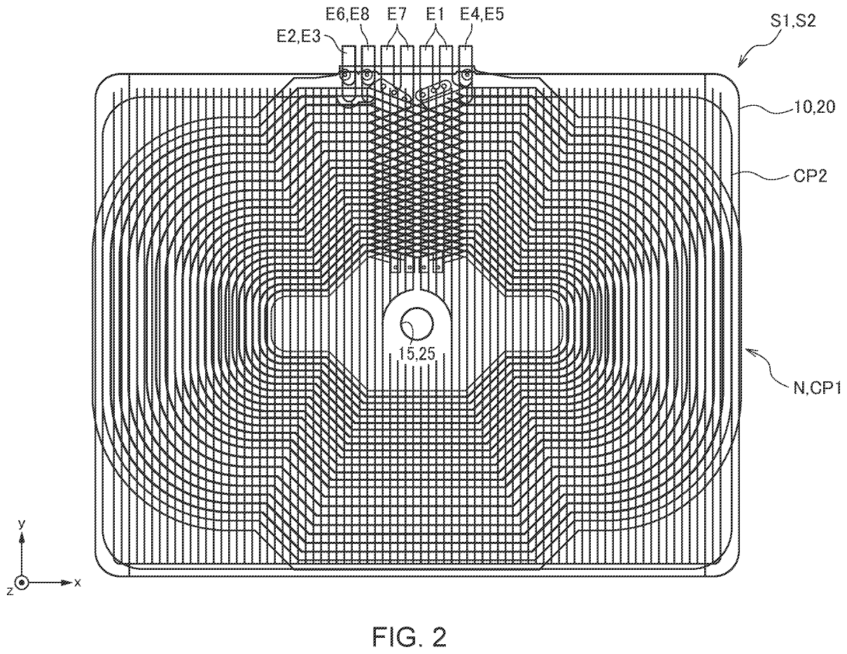

FIG. 2 is a schematic plan view for explaining a state where the first and second circuit sheets S1 and S2 overlap each other. As illustrated in FIG. 2, the coil pattern CP1 included in the first circuit sheet S1 and the coil pattern cp2 and noise suppression pattern N included in the second circuit sheet S2 overlap one another in the z-direction as the stacking direction. The following describes in detail the pattern shapes of the noise suppression pattern N, coil pattern CP1, and coil pattern CP2.

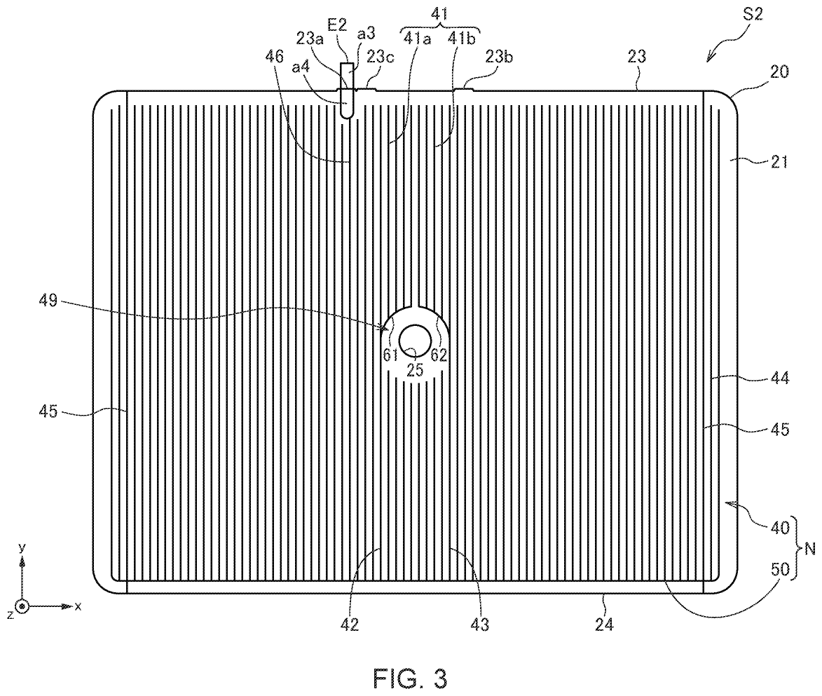

FIG. 3 is a plan view for explaining the pattern shape of the second conductor pattern provided on the surface 21 of the second substrate 20.

As illustrated in FIG. 3, the second conductor pattern provided on the surface 21 of the second substrate 20 includes the noise suppression pattern N and a second terminal conductor E2. The noise suppression pattern N has a plurality of linear patterns 40 extending in the y-direction as a first direction and a connection pattern 50 extending in the x-direction as a second direction and connecting the plurality of linear patterns 40. In the example illustrated in FIG. 3, the plurality of linear patterns 40 all linearly extend in the y-direction and are arranged in the x-direction at a constant pitch, but not limited thereto. For example, the plurality of linear patterns 40 may extend in the y-direction while meandering, or may extend while inclining at a predetermined angle with respect to the y-direction. Further, the pitch between the plurality of linear patterns 40 in the x-direction may vary depending on the planar position.

The surface 21 of the second substrate 20 has a clearance area 49 surrounded by the plurality of linear patterns 40 and having no conductor pattern. In the example illustrated in FIG. 3, the clearance area 49 is circular in shape, and the first through hole 25 is formed at substantially the center thereof. In the example illustrated in FIG. 3, the first through hole 25 is also circular in shape. The clearance area 49 is an area for avoiding interference between the first through hole 25 and the linear patterns 40 and is larger in size than the first through hole 25. Further, the size of the clearance area 49 in the x-direction is larger than the arrangement pitch between the plurality of linear patterns 40 in the x-direction. Thus, some linear patterns 40 are divided in the y-direction by the clearance area 49.

In more detail, the plurality of linear patterns 40 include a plurality of first linear patterns 41 whose positions in the x-direction overlap the clearance area 49 and are not in direct contact with the connection pattern 50. The linear patterns 41 are positioned at the positive y-direction side of the clearance area 49, and the end portions thereof at the positive y-direction side are opened. The first linear patterns 41 have a first group 41a positioned at the negative x-direction side with respect to the center of the clearance area 49 and a second group 41b positioned at the positive x-direction side with respect to the center of the clearance area 49. The first and second groups 41a and 41b each include the plurality of first linear patterns 41.

Since some linear patterns 40 are divided in the y-direction by the clearance area 49, the plurality of linear patters 40 include a plurality of linear patterns positioned at the negative y-direction side of the clearance area 49. One end portions in the y-direction (end portions at the negative y-direction side) of these linear patterns are connected to the connection pattern 50, and the other end portions in the y-direction (end portions at the positive y-direction side) of these linear patterns are opened along the outer periphery of the clearance area 49.

The plurality of linear patterns 40 further include a second linear pattern 42 whose position in the x-direction does not overlap the clearance area 49 and is adjacent in the x-direction to one of the first linear pattern 41 belonging to the first group 41a that is positioned at the most negative x-direction side and a third linear pattern 43 whose position in the x-direction does not overlap the clearance area 49 and is adjacent in the x-direction to one of the first linear pattern 41 belonging to the second group 41b that is positioned at the most positive x-direction side. One end portions of the respective second and third linear patterns 42 and 43 are connected to the connection pattern 50, and the other end portions thereof are opened.

The first linear patterns 41 belonging to the first group 41a are each not directly connected to the connection pattern 50 but connected to the second linear pattern 42 through a first connection part 61 disposed along the outer periphery of the clearance area 49. As a result, the first linear patterns 41 belonging to the first group 41a are each also electrically connected to the connection pattern 50 through the first connection part 61 and second linear pattern 42. Similarly, the first linear patterns 41 belonging to the second group 41b are each not directly connected to the connection pattern 50 but connected to the third linear pattern 43 through a second connection part 62 disposed along the outer periphery of the clearance area 49. As a result, the first linear patterns 41 belonging to the second group 41b are each also electrically connected to the connection pattern 50 through the second connection part 62 and third linear pattern 43. Since the first and second connection parts 61 and 62 are disposed along the outer periphery of the clearance area 49, the electrical length between the connection pattern 50 and the first linear patterns 41 can be reduced to thereby enhance noise suppression effect. Further, the first and second connection parts 61 and 62 are not directly connected to each other, thereby preventing the formation of a loop passing the second and third linear patterns 42 and 43.

As illustrated in FIG. 3, most of the plurality of linear patterns 40 are constituted by fourth linear patterns 44 whose one end portions in the y-direction (end portions at the negative y-direction side) are connected to the connection pattern 50 and whose other end portions in the y-direction (end portions at the positive y-direction side) are opened in the vicinity of an edge 23 of the second substrate 20. The edge 23 extends in the x-direction, and the connection pattern 50 is provided along an edge 24 positioned on the side opposite to the edge 23. The plurality of linear patterns 40 further include fifth linear patterns 45 whose one end portions in the y-direction protrude, beyond the connection pattern 50, to the edge 24 and whose other end portions in the y-direction protrude, beyond the other end portions of the fourth linear patterns 44, to the edge 23. The fifth linear patterns 45 is longer in length in the y-direction than the fourth linear patterns 44 and provided one by one in the vicinity of both ends in the x-direction in the example illustrated in FIG. 3. Like the fourth linear patterns 44, the fifth linear patterns 45 open at their other ends in the y-direction and thus have basically the same function as the fourth linear patterns 44; however, the fifth linear patterns 45 are longer in the y-direction than the fourth linear patterns 44, so that by partially disposing the fifth linear patterns 45, noise suppression effect can be enhanced.

The plurality of linear patterns 40 further include a sixth linear pattern 46 whose one end in the y-direction is connected to the connection pattern 50 and whose other end in the y-direction is connected to the second terminal conductor E2. Only one sixth linear pattern 46 is formed. The second terminal conductor E2 is connected to a ground potential in actual use. This fixes the entire noise suppression pattern N to the ground potential. In the present embodiment, the second terminal conductor E2 is not directly connected to the connection pattern 50 but connected to the tip end of the sixth linear pattern 46 which is one of the linear patterns 40, thereby allowing the connection pattern 50 to be linear and making the pattern width thereof substantially constant. In addition, since the second terminal conductor E2 is connected to one sixth linear pattern 46, a loop is not formed unlike a case where the second terminal conductor E2 is connected to the plurality of linear patterns 40. Further, the arrangement area for the plurality of linear patterns 40 can be increased, allowing noise suppression effect to be enhanced.

The second terminal conductor E2 includes a third part a3 protruding from the second substrate 20 and a fourth part a4 disposed on the second substrate 20. The fourth part a4 is connected to the sixth linear pattern 46. The width of the fourth part a4 of the second terminal conductor E2 in the x-direction is larger than the pitch between the plurality of linear patterns 40 in the x-direction. Thus, the linear patterns 40 adjacent to the sixth linear pattern 46 are reduced in length in the y-direction so as not to interfere with the fourth part a4 of the second terminal conductor E2. As a result, a part of the fourth part a4 of the second terminal conductor E2 is adjacent in the x-direction to some of the plurality of linear patterns 40. In other words, a part of the fourth part a4 of the second terminal conductor E2 is sandwiched by two linear patterns 40 in the x-direction. This sufficiently ensures the length of the fourth part a4 of the second terminal conductor E2 in the y-direction to thereby enhance adhesion between the second terminal conductor E2 and the second substrate 20.

Further, as illustrated in FIG. 3, although most part of the edge 23 of the second substrate 20 extends linearly in the x-direction, it has a protruding part 23a that protrudes in the y-direction at a part thereof overlapping the second terminal conductor E2. The protruding part 23a plays a role of enhancing adhesion between the second terminal conductor E2 and the second substrate 20 so as to increase mechanical strength of the second terminal conductor E2. The edge 23 of the second substrate 20 has other protruding parts 23b and 23c.

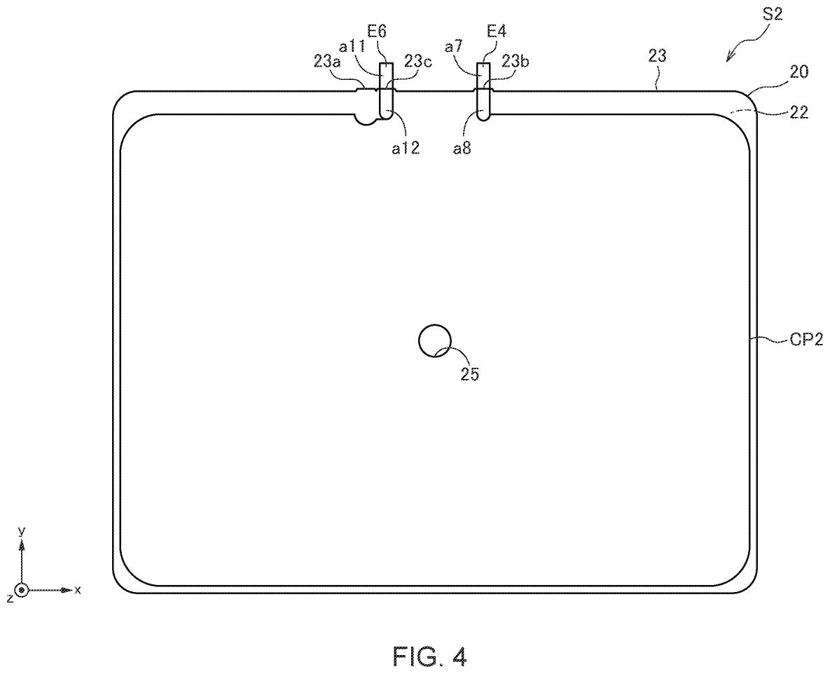

FIG. 4 is a plan view for explaining the pattern shape of the third conductor pattern provided on the surface 22 of the second substrate 20, which illustrates a state as viewed from the surface 21 side of the second substrate 20, that is, a state as seen through the second substrate 20.

As illustrated in FIG. 4, a conductor pattern provided on the surface 22 of the second substrate 20 includes the coil pattern CP2 and fourth and sixth terminal conductors E4 and E6. The coil pattern CP2 is a pattern wound in about one turn along the edge of the second substrate 20. One end portion of the coil pattern CP2 is connected to the fourth terminal conductor E4, and the other end thereof is connected to the sixth terminal conductor E6. The fourth and sixth terminal conductors E4 and E6 are provided at positions overlapping respectively the protruding parts 23b and 23c of the edge 23. The fourth terminal conductor E4 includes a seventh part a7 protruding from the second substrate 20 and an eighth part a8 disposed on the second substrate 20. The eighth part a8 is connected to the one end portion of the coil pattern CP2. The sixth terminal conductor E6 includes an 11th part a11 protruding from the second substrate 20 and a 12th part a12 disposed on the second substrate 20. The 12th part a12 is connected to the other end portion of the coil pattern CP2.

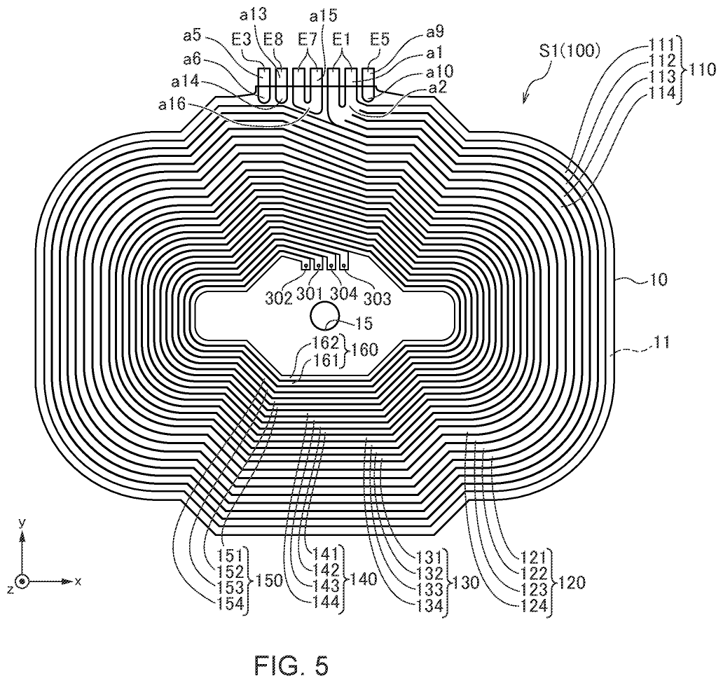

FIG. 5 is a plan view for explaining the pattern shape of the coil pattern 100, which illustrates a state as viewed from the surface 12 side of the first substrate 10, that is, a state as seen through the first substrate 10.

The coil pattern 100 has a six-turn configuration including turns 110, 120, 130, 140, 150, and 160, in which the turns 110 and 160 are positioned at the outermost and innermost peripheries, respectively. The turns 110, 120, 130, 140, and 150 are each radially divided into four by three spiral slits. The turn 160 is radially divided into two by one spiral slit. Specifically, the turn 110 is divided into four lines 111 to 114, the turn 120 is divided into four lines 121 to 124, the turn 130 is divided into four lines 131 to 134, the turn 140 is divided into four lines 141 to 144, the turn 150 is divided into four lines 151 to 154, and the turn 160 is divided into two lines 161 and 162.

The lines 111, 121, 131, 141, 151, and 161 are continuous lines spirally wound in six turns and are each positioned at the outermost periphery in its corresponding turn. The lines 112, 122, 132, 142, 152, and 162 are continuous lines spirally wound in six turns and are each the second line counted from the outermost peripheral line in its corresponding turn. The lines 113, 123, 133, 143, and 153 are continuous lines spirally wound in five turns and are each the second line counted from the innermost peripheral line in its corresponding turn. The lines 114, 124, 134, 144, and 154 are continuous lines spirally wound in five turns and are each positioned at the innermost periphery in its corresponding turn.

The outer peripheral ends of the lines 111 to 114 are connected in common to a first terminal conductor E1. The inner peripheral ends of the lines 161, 162, 153, and 154 are connected respectively to first to fourth through hole conductors 301 to 304 penetrating the first substrate 10. Further, on the surface 11 of the first substrate 10, third, fifth, seventh, and eighth terminal conductors E3, E5, E7, and E8 are formed separately from the coil pattern 100. The first terminal conductor E1 includes a first part a1 protruding from the first substrate 10 and a second part a2 disposed on the first substrate 10. The second part a2 is connected to the coil pattern 100. On the other hand, the third, fifth, and eighth terminal conductors E3, E5, and E8 are not connected to the coil pattern 100. The seventh terminal conductor E7 is not connected to the coil pattern 100 on the surface 11 of the first substrate 10 but is connected to the coil pattern 200 as will be described later to be consequently connected to the coil pattern 100 through the coil pattern 200.

The third terminal conductor E3 includes a fifth part a5 protruding from the first substrate 10 and a sixth part a6 disposed on the first substrate 10. The fifth terminal conductor E5 includes a ninth part a9 protruding from the first substrate 10 and a 10th part a10 disposed on the first substrate 10. The eighth terminal conductor E8 includes a 13th part a13 protruding from the first substrate 10 and a 14th part a14 disposed on the first substrate 10. The seventh terminal conductor E7 includes a 15th part a15 protruding from the first substrate 10 and a 16th part a16 disposed on the first substrate 10.

The tip end of the first terminal conductor E1 is divided into two division patterns E1a and E1b, and the tip end of the seventh terminal conductor E7 is divided into two division patterns E1a and E7b. This allows two connector pins to be described later to be connected to each of the terminal conductors E1 and E7, so that an external stress to be applied through the connector pin is distributed. The division point at which each of the terminal conductors E1 and E7 is divided is positioned on the surface 11 of the first substrate 10.

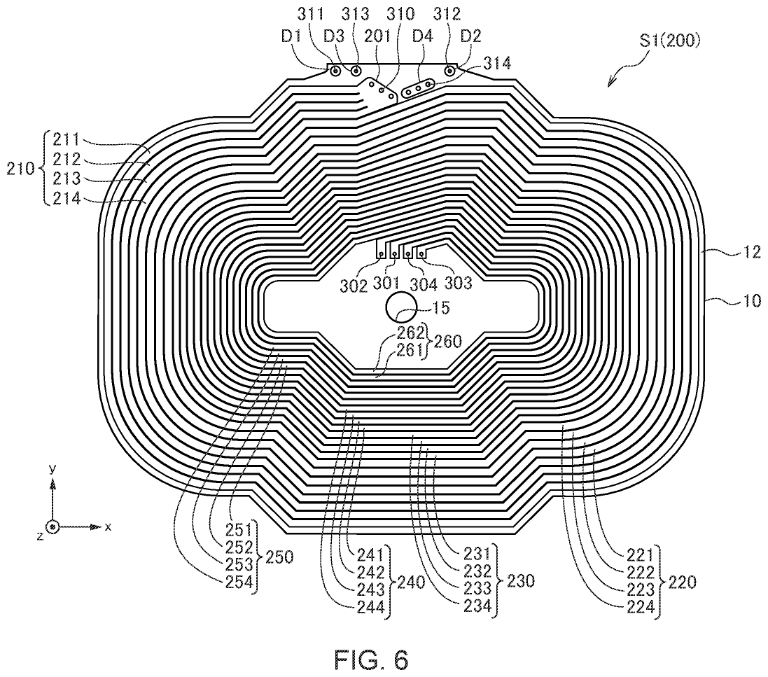

FIG. 6 is a plan view for explaining the pattern shape of the coil pattern 200, which illustrates a state as viewed from the surface 11 side of the first substrate 10.

As illustrated in FIG. 6, the pattern shape of the main part of the coil pattern 200 is the same as the pattern shape of the main part of the coil pattern 100. The coil pattern 200 has a six-turn configuration including turns 210, 220, 230, 240, 250, and 260, in which the turn 210 and turn 260 are positioned at the outermost and innermost peripheries, respectively. The turns 210, 220, 230, 240, and 250 are each radially divided into four by three spiral slits. The turn 260 is radially divided into two by one spiral slit. Specifically, the turn 210 is divided into four lines 211 to 214, the turn 220 is divided into four lines 221 to 224, the turn 230 is divided into four lines 231 to 234, the turn 240 is divided into four lines 241 to 244, the turn 250 is divided into four lines 251 to 254, and the turn 260 is divided into two lines 261 and 262.

The lines 211, 221, 231, 241, 251, and 261 are continuous lines spirally wound in six turns and are each positioned at the outermost periphery in its corresponding turn. The lines 212, 222, 232, 242, 252, and 262 are continuous lines spirally wound in six turns and are each the second line counted from the outermost peripheral line in its corresponding turn. The lines 213, 223, 233, 243, and 253 are continuous lines spirally wound in five turns and are each the second line counted from the innermost peripheral line in its corresponding turn. The lines 214, 224, 234, 244, and 254 are continuous lines spirally wound in five turns and are each positioned at the innermost periphery in its corresponding turn.

The outer peripheral ends of the lines 211 to 214 are connected to a common pattern 201. The common pattern 201 is connected to the seventh terminal conductor E7 through a plurality of through hole conductors 310 penetrating the first substrate 10. As a result, the outer peripheral end of the coil pattern 200 is connected to the seventh terminal conductor E7. On the other hand, the inner peripheral ends of the lines 261, 262, 253, and 254 are connected respectively to through hole conductors 304, 303, 302, and 301.

Further, on the surface 12 of the first substrate 10, auxiliary conductors D1 to D4 are formed separately from the coil pattern 200. The auxiliary conductors D1 to D3 are not connected to the coil patterns 100 and 200. The auxiliary conductor D1 is connected to the sixth part a6 of the third terminal conductor E3 through a through hole conductor 311 penetrating the first substrate 10. The auxiliary conductor D2 is connected to the 10th part a10 of the fifth terminal conductor E5 through a through hole conductor 312 penetrating the first substrate 10. The auxiliary conductor D3 is connected to the 14th part a14 of the eighth terminal conductor E8 through a through hole conductor 313 penetrating the first substrate 10. The auxiliary conductor D4 is connected to the second part a2 of the first terminal conductor E1 through a through hole conductor 314 penetrating the first substrate 10. As described above, the terminal conductors E3, E5, E8, and E1 provided on the surface 11 of the first substrate 10 are connected respectively to the auxiliary conductors D1 to D4 formed on the surface 12 of the first substrate 10 respectively through the through hole conductors 311 to 314. Thus, the terminal conductors E3, E5, E8, and E1 are fixed more firmly to the surface 11 of the first substrate 10, making peeling less likely to occur.

Further, the end portion of the sixth part a6 of the third terminal conductor E3, the end portion of the 10th part a10 of the fifth terminal conductor E5, and the end portion of the 14th part a14 of the eighth terminal conductor E8 are rounded, electric field concentration at these end portions is alleviated. In addition, the sixth part a6 of the third terminal conductor E3, the 10th part a10 of the fifth terminal conductor E5, and the 14th part a14 of the eighth terminal conductor E8 are smaller in length than the second part a2 of the first terminal conductor E1, so that it is possible to mitigate the influence of the third, fifth, and eighth conductors E3, E5, and E8 on the coil pattern 100. On the other hand, the fourth part a4 of the second terminal conductor E2 is larger in length than the sixth part a6 of the third terminal conductor E3, the 10th part a10 of the fifth terminal conductor E5, and the 14th part a14 of the eighth terminal conductor E8 and is partly surrounded by the linear patterns 40, thus making it possible to enhance adhesion between the second terminal conductor E2 and the second substrate 20. A state where the fourth part a4 of the second terminal conductor E2 is partly surrounded by the linear patterns 40 includes a case where the end portion of the fourth part a4 of the second terminal conductor E2 is partly surrounded by the linear patterns 40 from three directions of the positive x-direction, negative x-direction, and negative y-direction.

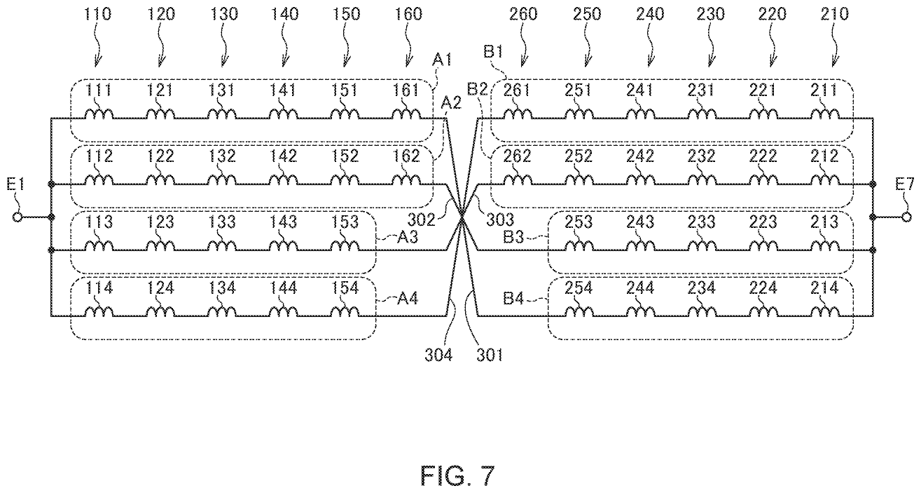

FIG. 7 is an equivalent circuit diagram of the coil pattern CP1.

As illustrated in FIG. 7, a line group A1 of six turns including the lines 111, 121, 131, 141, 151, and 161 and a line group B4 of five turns including the lines 214, 224, 234, 244, and 254 are connected in series through the through hole conductor 301 to constitute a continuous line wound in 11 turns in total. A line group A2 of six turns including the lines 112, 122, 132, 142, 152, and 162 and a line group B3 of five turns including the lines 213, 223, 233, 243, and 253 are connected in series to each other through the through hole conductor 302 to constitute a continuous line wound in 11 turns in total. A line group A3 of five turns including the lines 113, 123, 133, 143, and 153 and a line group B2 of six turns including the lines 212, 222, 232, 242, 252, and 262 are connected in series to each other through the through hole conductor 303 to constitute a continuous line wound in 11 turns in total. A line group A4 of five turns including the lines 114, 124, 134, 144, and 154 and a line group B1 of six turns including the lines 211, 221, 231, 241, 251, and 261 are connected in series to each other through the through hole conductor 304 to constitute a continuous line wound in eleven turns in total.

Thus, four 11-turn lines are connected in parallel between the terminal electrodes E1 and E7 constituting both ends of the coil patterns 100 and 200. This makes uniform the density distribution of current flowing in the coil patterns 100 and 200, allowing a reduction in DC resistance and AC resistance. In addition, the line group A1 which is the outermost peripheral group is connected to the line group B4 which is the innermost peripheral group, the line group A2 which is the second group counted from the outermost peripheral group is connected to the line group B3 which is the second group counted from the innermost peripheral group, the line group A3 which is the second group counted from the innermost peripheral group is connected to the line group B2 which is the second group counted from the outermost peripheral group, and the line group A4 which is the innermost peripheral group is connected to the line group B1 which is the outermost peripheral group. This cancels a difference between inner and outer peripheries of the coil pattern 100 and a difference between inner and outer peripheries of the coil pattern 200, thereby allowing a further reduction in DC resistance and AC resistance. Further, the line groups A1, A2, B1, and B2 each have a six-turn configuration, and the line groups A3, A4, B3, and B4 each have a five-turn configuration, so that the total number of turns can be odd number even through the coil patterns 100 and 200 formed on the front and back surfaces of the first substrate 10 have the same pattern shape.

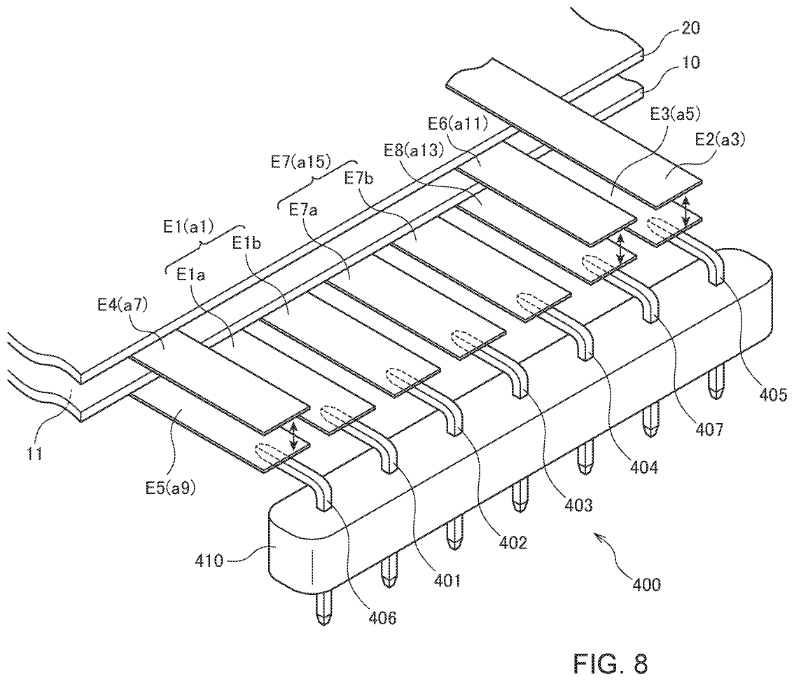

FIG. 8 is a schematic perspective view illustrating a state where a connector member 400 is connected to the terminal conductors E1 to E8.

As illustrated in FIG. 8, the connector member 400 has seven connector pins 401 to 407 constituting external terminals and a resin case 410 into which the connector pins 401 to 407 are inserted. The connector pins 401 to 407 each have a rod-like body made of metal such as copper and formed into a shape bent at 90°. Using the thus configured connector member 400 facilitates the connection between the electric circuit device 1 according to the present embodiment and a device (switching power supply circuit, etc.) mounting the electric circuit device 1.

The connector pins 401 and 402 are connected respectively to the division patterns E1a and E1b constituting the terminal conductor E1. The connector pins 401 and 402 constitute a first external terminal. The connector pins 403 and 404 are connected respectively to the division patterns E1a and E7b constituting the terminal conductor E7. The connector pins 405 to 407 are connected respectively to the terminal conductors E3, E5, and E8. The connector pin 405 constitutes a second external terminal. The connector pins 401 to 407 are each joined to a part of its corresponding terminal conductor that protrudes from the first substrate 10 or second substrate 20 by ultrasonic joining. In the present embodiment, the connector pins 401 to 407 are each joined to the surface (lower surface) of its corresponding terminal conductor on the surface 11 side of the first substrate 10, so that they do not protrude to the surface 21 side of the second substrate 20. This prevents the housing 2 illustrated in FIG. 1 and the connector pins 401 to 407, thus allowing a reduction in distance between the first and second circuit sheets S1, S2 and the placement surface 3 of the housing 2.

Further, the third part a3 (terminal conductor E2), seventh part a7 (terminal conductor E4), and 11th part a11 (terminal conductor E6) protruding from the second substrate 20 contact respectively the fifth part a5 25 (terminal conductor E3), ninth part a9 (terminal conductor E5), and 13th part a13 (terminal conductor E8) in an overlapping manner. That is, all the connector pins 401 to 407 are connected to the terminal conductors formed on the surface 11 of the first substrate 10. Thus, a level difference between the terminal conductor E2 and the connector pin 405, a level difference between the terminal conductor E4 and the connector pin 406, and a level difference between the terminal conductor E6 and the connector pin 407 are eliminated by the terminal conductors E3, E5, and E8, thereby increasing connection reliability between the terminal electrodes and the connector pins and enhancing the strength of the terminal conductors.

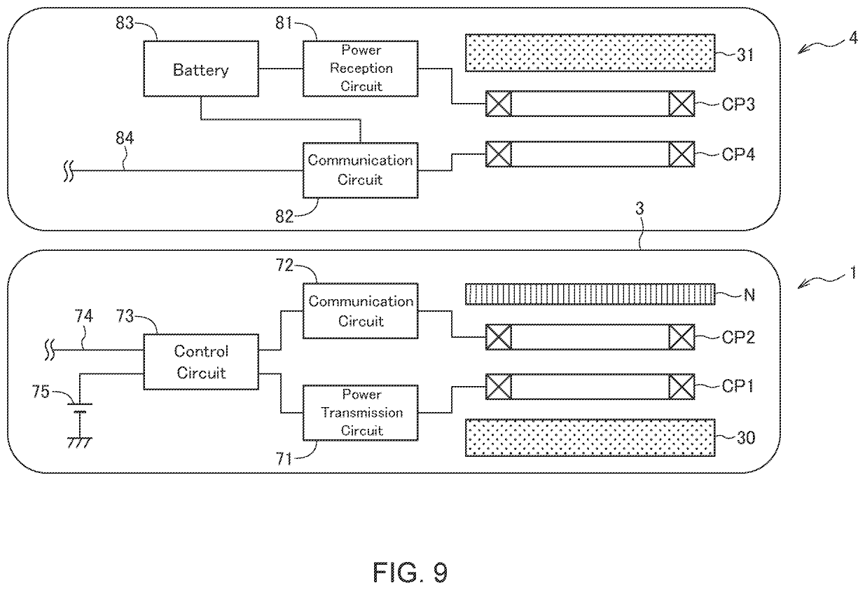

FIG. 9 is a block diagram illustrating the electric circuit device 1 according to the present embodiment and a mobile communication device 4 to be wirelessly connected to the electric circuit device 1.

As illustrated in FIG. 9, the electric circuit device 1 according to the present embodiment includes a power transmission circuit 71 connected to the coil pattern CP1, a communication circuit 72 connected to the coil pattern CP2, and a control circuit 73 connected to the power transmission circuit 71 and communication circuit 72. With this configuration, data to be exchanged through a communication line 74 can be communicated through the coil pattern CP2 as a communication coil for NFC, and the power to be supplied from a power supply 75 can be wirelessly transmitted through the coil pattern CP1 for wireless power transmission.

On the other hand, the mobile communication device 4 such as a smartphone includes a coil pattern CP3 as a power reception coil, a coil pattern CP4 as a communication coil for NFC, a power reception circuit 81 connected to the coil pattern CP3, a communication circuit 82 connected to the coil pattern CP4, and a battery 83 connected to the power reception circuit 81 and communication circuit 82. The coil pattern CP3 as a power reception coil is coupled to the coil pattern CP1 as a power transmission coil, and a coil pattern CP4 as a communication coil is coupled to the coil pattern CP2 as a communication coil. To enhance coupling between the coil patterns, the mobile communication device 4 has a magnetic member 31. Thus, data exchanged through a communication line 84 can be communicated through the coil pattern CP4, and the power received by the coil pattern CP3 as a power reception coil is used for charging the battery 83 through the power reception circuit 81. The battery 83 serves as an operation source for the communication circuit 82 and the like.

The electric circuit device 1 according to the present embodiment has the noise suppression pattern N between the coil pattern CP1 as a power transmission coil and the placement surface 3 of the housing 2, thereby reducing radiation noise generated from the coil pattern CP1. That is, most of magnetic flux generated from the coil pattern CP1 as a power transmission coil interlinks with the coil pattern CP3 as a power reception coil to thereby make AC current to flow in the coil pattern CP3. However, a part of magnetic flux that is generated from the coil pattern CP1 is radiated to the surroundings as radiation noise without interlinking with the coil pattern CP3. Such radiation noise may cause malfunction of surrounding electric devices and should desirably be suppressed as much as possible. The noise suppression pattern N is provided for reducing such radiation noise and is disposed between the coil pattern CP1 as a power transmission coil and the coil pattern CP3 as a power reception coil and in the vicinity of the coil pattern CP1, whereby it is possible to block much radiation noise while sufficiently ensuring magnetic flux that interlinks with the coil pattern CP3.

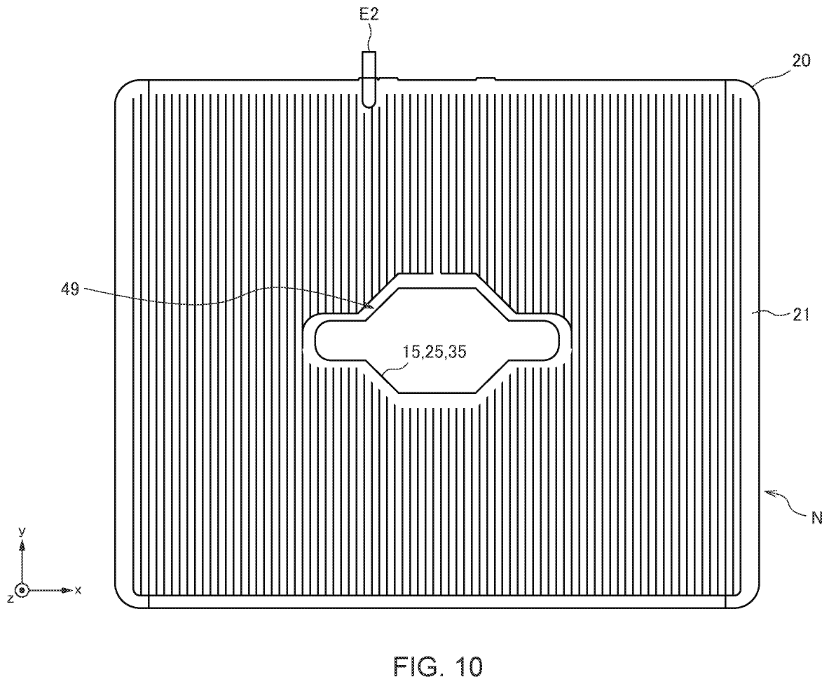

FIG. 10 is a plan view for explaining the pattern shape of the noise suppression pattern N according to a modification.

In the noise suppression pattern N according to the modification illustrated in FIG. 10, the clearance area 49 is formed into a shape conforming to the shape of the opening of the coil pattern CP1 as a power transmission coil. Correspondingly, the through holes 15, 25, and 35 formed respectively in the first substrate 10, second substrate 20, and magnetic member 30 are each formed into a shape conforming to the opening of the coil pattern CP1. Thus, when cooling air is supplied to the housing 2 through the through holes 15, 25, and 35, for example, the amount of air to be supplied can significantly be increased. Further, an area where a device to be disposed in the through holes 15, 25, and 35 can be extended, allowing a larger device to be disposed therein.

While the preferred embodiment of the present disclosure has been described, the present disclosure is not limited to the above embodiment, and various modifications may be made within the scope of the present disclosure, and all such modifications are included in the present disclosure.

For example, the first connection part 61 may be configured to connect the other end portion of the second linear pattern 42 and the end portions in the positive y-direction of the first linear patterns 41 belonging to the first group 41a. Similarly, the second connection part 62 may be configured to connect the other end portion of the third linear pattern 43 and the end portions in the positive y-direction of the first linear patterns 41 belonging to the second group 41b.

Further, the conductor patterns (first to third conductor patterns), terminal conductors E1 to E8, and auxiliary conductors D1 to D4 provided on the substrates 10 and 20 may be provided on the surface of the substrate 10 or 20 with another material layer made of, e.g., resin interposed therebetween.

The technology according to the present disclosure includes the following configuration examples but not limited thereto.

A noise suppression sheet according to the present disclosure includes a substrate having a first through hole and a conductor pattern provided on one surface of the substrate. The conductor pattern has a plurality of linear patterns extending in a first direction and a connection pattern connecting the plurality of linear patterns. The one surface of the substrate has a clearance area surrounded by the plurality of linear patterns and having no conductor pattern. The size of the clearance area in a second direction different from the first direction is larger than the arrangement pitch between the plurality of linear patterns in the second direction. The first through hole is formed in the clearance area. With this configuration, another device such as a temperature sensor or a cooling mechanism can be disposed in the first through hole.

The plurality of linear patterns may include a plurality of first linear patterns each of whose positions in the second direction overlaps the clearance area and has no direct contact with the connection pattern and a second linear pattern whose position in the second direction does not overlap the clearance area and is adjacent to any of the plurality of first linear patterns, and the conductor pattern may further have a connection part connecting the plurality of first linear patterns and second linear pattern. With this configuration, the plurality of first linear patterns overlapping the clearance area can be connected to the connection pattern through the second linear pattern. In this case, the connection part may be disposed along the outer periphery of the clearance area. This reduces a distance for connecting the plurality of first linear patterns and the connection pattern, thus enhancing noise suppression effect.

The plurality of first linear patterns may include first and second groups each including a plurality of linear patterns, the second linear pattern may be adjacent to any of the plurality of first linear patterns belonging to the first group, the plurality of linear patterns may further include a third linear pattern whose position in the second direction does not overlap the clearance area and is adjacent to any of the plurality of first linear patterns belonging to the second group, and the connection part may include a first connection part connecting the first linear patterns belonging to the first group and the second linear pattern and a second connection part connecting the first linear patterns belonging to the second group and the third linear pattern. With this configuration, the number of the first linear patterns to be connected to one linear pattern can be reduced. This reduces a distance for connecting the plurality of first linear patterns and the connection pattern, thus enhancing noise suppression effect.

The plurality of linear patterns may further include a plurality of fourth linear patterns each of whose one ends in the first direction is connected to the connection pattern and each of whose other ends in the first direction is opened and a fifth linear pattern whose one end in the first direction protrudes beyond the connection pattern and whose other end in the first direction is opened and protrudes beyond the other end of the fourth liner pattern. This makes it possible to enhance noise suppression effect.

The conductor pattern may further include a terminal conductor, and the plurality of linear patterns may further include a sixth linear pattern whose one end in the first direction is connected to the connection pattern and whose other end in the first direction is connected to the terminal conductor. This can make the linear patterns have a linear shape and the pattern width thereof substantially constant. In this case, a part of the terminal conductor may be adjacent to any of the plurality of linear patterns in the second direction. This enhance adhesion between the terminal conductor and the first substrate. Further, one edge of the substrate in the first direction may protrude at a part thereof overlapping the terminal conductor. This further enhances adhesion between the terminal conductor and the first substrate.

The noise suppression sheet according to the present disclosure may further include a communication coil provided on the other surface of the substrate. This makes it possible to make the noise suppression sheet multifunctional without increasing the number of components.

An electric circuit device according to the present disclosure includes the above-described noise suppression sheet and a power transmission coil overlapping the noise suppression sheet, and the opening of the power transmission coil overlaps the first through hole. This makes it possible to reduce radiation noise from the power transmission coil.

The electric circuit device according to the present disclosure may further include a magnetic member disposed on the side opposite to the substrate with respect to the power transmission coil, and the magnetic member may have a second through hole overlapping the first through hole. This makes it possible to increase inductance of the power transmission coil and to dispose another device such as a temperature sensor or a cooling mechanism in the first and second through holes. In this case, the second through hole may be smaller in size than the first through hole. This allows a part of the substrate that is positioned around the first through hole to be supported by the magnetic member.

The clearance area may have a shape conforming to the shape of the opening of the power transmission coil. This allows a larger device to be disposed in the first and second through holes.

What is claimed is:

1. A noise suppression sheet comprising:
a substrate having a first through hole; and
a conductor pattern provided on one surface of the substrate,
wherein the conductor pattern has a plurality of linear patterns extending in a first direction and a connection pattern connecting the plurality of linear patterns,
wherein the one surface of the substrate has a clearance area surrounded by the plurality of linear patterns and having no conductor pattern,
wherein a size of the clearance area in a second direction different from the first direction is larger than an arrangement pitch between the plurality of linear patterns in the second direction, and
wherein the first through hole is formed in the clearance area.

2. The noise suppression sheet as claimed in claim 1,
wherein the plurality of linear patterns include a plurality of first linear patterns each of whose positions in the second direction overlaps the clearance area and has no direct contact with the connection pattern and a second linear pattern whose position in the second direction does not overlap the clearance area and is adjacent to any of the plurality of first linear patterns, and
wherein the conductor pattern further has a connection part connecting the plurality of first linear patterns and second linear pattern.

3. The noise suppression sheet as claimed in claim 2, wherein the connection part is disposed along an outer periphery of the clearance area.

4. The noise suppression sheet as claimed in claim 3,
wherein the plurality of first linear patterns include first and second groups each including a plurality of linear patterns,
wherein the second linear pattern is adjacent to any of the plurality of first linear patterns belonging to the first group,
wherein the plurality of linear patterns further include a third linear pattern whose position in the second direction does not overlap the clearance area and is adjacent to any of the plurality of first linear patterns belonging to the second group, and
wherein the connection part includes a first connection part connecting the first linear patterns belonging to the first group and the second linear pattern and a second connection part connecting the first linear patterns belonging to the second group and the third linear pattern.

5. The noise suppression sheet as claimed in claim 1, wherein the plurality of linear patterns further include a plurality of fourth linear patterns each of whose one ends in the first direction is connected to the connection pattern and each of whose other ends in the first direction is opened and a fifth linear pattern whose one end in the first direction protrudes beyond the connection pattern and whose other end in the first direction is opened and protrudes beyond an other end of the fourth liner pattern.

6. The noise suppression sheet as claimed in claim 1,
wherein the conductor pattern further includes a terminal conductor, and
wherein the plurality of linear patterns further include a sixth linear pattern whose one end in the first direction is connected to the connection pattern and whose other end in the first direction is connected to the terminal conductor.

7. The noise suppression sheet as claimed in claim 6, wherein a part of the terminal conductor is adjacent to any of the plurality of linear patterns in the second direction.

8. The noise suppression sheet as claimed in claim 6, wherein one edge of the substrate in the first direction protrudes at a part thereof overlapping the terminal conductor.

9. The noise suppression sheet as claimed in claim 1, further comprising a communication coil provided on another surface of the substrate.

10. An electric circuit device comprising:
a noise suppression sheet; and
a power transmission coil overlapping the noise suppression sheet,
wherein the noise suppression sheet comprising:
a substrate having a first through hole;
a conductor pattern provided on one surface of the substrate; and
a communication coil provided on another surface of the substrate,
wherein the conductor pattern has a plurality of linear patterns extending in a first direction and a connection pattern connecting the plurality of linear patterns,
wherein the one surface of the substrate has a clearance area surrounded by the plurality of linear patterns and having no conductor pattern,
wherein a size of the clearance area in a second direction different from the first direction is larger than an arrangement pitch between the plurality of linear patterns in the second direction,
wherein the first through hole is formed in the clearance area, and
wherein an opening of the power transmission coil overlaps the first through hole.

11. The electric circuit device as claimed in claim 10, further comprising a magnetic member disposed on a side opposite to the substrate with respect to the power transmission coil,
wherein the magnetic member has a second through hole overlapping the first through hole.

12. The electric circuit device as claimed in claim 11, wherein the second through hole is smaller in size than the first through hole.

13. The electric circuit device as claimed in claim 10, wherein the clearance area has a shape conforming to the shape of an opening of the power transmission coil.
